(19) United States
(12) Patent Application Publication
(10) Pub. No.: US 2010/0086513 A1
(43) Pub. Date: Apr. 8, 2010

(54) Method for Effecting Antimicrobial Activity Using Polyamine Analogues

(76) Inventors: Marcos A. Oliveira, San Antonio, TX (US); Brian W. Wortham, Lexington, KY (US); Patrick M. Woster, Cauton, MI (US); Mary Pat Moyer, San Antonio, TX (US)

Correspondence Address: STRASBURGER & PRICE, LLP, 901 MAIN STREET, SUITE 4400, DALLAS, TX, 75202, US

(21) Appl. No.: 12/569,994

(22) Filed: Sep. 30, 2009

Related U.S. Application Data
(60) Provisional application No. 61/194,771, filed on Sep. 30, 2008.

(51) Int. Cl. A01N 33/02; A01P 1/00

(52) U.S. Cl. 424/78.08

(57) ABSTRACT

A method for using polyamine analogues containing bulky hydrophobic groups against antimicrobial agents is disclosed. The antimicrobial method works by the mechanical action of disrupting the protective outer member of a bacterial cell.

### CROSS REFERENCE TO RELATED APPLICATION

This application claims the benefit of Provisional U.S. Patent Application No. 61/194,771 filed Sep. 30, 2009.

### STATEMENT REGARDING FEDERALLY FUNDED RESEARCH AND DEVELOPMENT

The invention described in this patent application was not the subject of federally sponsored research or development.

### FIELD

This invention relates to a method of using polyamine analogues as antimicrobial agents in clinically relevant bacteria. More specifically, it relates to the method of using the antimicrobial effects of polyaminobiguanidine analogues containing bulky hydrophobic groups which result from the mechanical disruption of the protective outer membrane of Y. pestis, and other relevant bacteria.

### BACKGROUND

Polyamines are small cationic molecules that are thought to exist in virtually all living organisms. The basic polyamine unit is a three to five carbon length alkyl chain, flanked at both ends by a pair of individual amino groups. Organisms assemble these basic polyamine units in a number of different combinations. The three most common forms of polyamines are putrescine, spermidine, and spermine. Spermidine and spermine are a triamine and tertramine, respectively. Both spermidine and spermine derive from the diamine putrescine. The four positive amino groups found in spermine produce the most pronounced polybasic characteristics of the three most common polyamines. The polybasic character of polyamines allows polyamines to strongly bond to nucleic acids and to stabilize DNA strands. DNA is stabilized following bonding of the cationic polyamines to the negatively charged anionic phosphate groups.

Polyamines have been implicated in a number of different intracellular mechanisms, including modulating the synthesis of DNA, RNA, and proteins. Normal cell growth and cell differentiation requires adequate polyamine levels. In Escherichia coli, polyamine homeostasis is necessary for growth. In Y. pestis, polyamines regulate the production of the anti-phagocytic slime layer. The important roles that polyamines play in a number of intracellular processes result from the characteristic and flexible charge distribution of the cationic polyamines.

Adequate cellular polyamine levels result from a balance between the production, degradation, and uptake of the polyamines. Two main pathways control the production of polyamines in bacteria. The first pathway is regulated by the enzyme ornithine decarboxylase (ODC, or SpeC). ODC is responsible for the decarboxylation of ornithine to form putrescine. The second pathway is controlled by arginine decarboxylase (ADC, or SpeA), which initiates the production of putrescine through the decarboxylation of arginine. The actions of ODC and ADC are considered the first steps in the polyamine biosynthetic pathway towards producing the polyamine putrescine.

The bacteria Y. pestis is found on every populated continent and is responsible for the bubonic plague, a zootonic disease that ravaged Europe during the 6^{th} and 14^{th} centuries, killing 125 million people. Carried by rodents and transmitted by infected fleas, the effects of the bubonic plague occur within a week of being bitten by one of these infected fleas. Replication of the bacteria within its host produces the characteristic “bubo,” or swollen lymph node, and results in death in about 40 to 70% of those affected. Although the number of bubonic plague cases in humans occurring each year, as confirmed by the World Health Organization, are relatively low, numbering around 2,000, small epidemics of Y. pestis caused diseases occur yearly.

Even though bubonic plague outbreaks are relatively contained, a continuing interest exists in the development of novel antimicrobial treatments against Y. pestis for the following two reasons.

First, it is important to isolate antibiotic-resistant strains of Y. pestis. Antibiotic-resistant strains of Y. pestis, caused by inserted plasmids, are capable of transferring their resistance to antibiotics to other non-resistant strains of Y. pestis. Isolating the antibiotic-resistant strains and providing antimicrobial treatments could curtail transfer of these antibiotic-resistant plasmids within antibiotic-resistant strains of Y. pestis.

Second, Y. pestis has the potential for use as a weapon of bioterrorism. The organism can be easily propagated and dispersed with a high infectivity rate and a high potential to cause a rapidly developing, severe disease among humans. Bubonic plague resulting from Y. pestis infection has already been used in modern times as a biological warfare agent. Consequently, the Centers for Disease Control and Prevention classified Y. pestis as a category A potential bioterrorism agent, only one of five bacteria to carry this highest priority designation. Developing an antimicrobial treatment for virulent Y. pestis strains could stop the use of Y. pestis as a potent biological weapon.

Accordingly, a need remains in the art for an antimicrobial method against Y. pestis and other clinically relevant bacteria.

### SUMMARY

The disclosed invention provides an antimicrobial method against Y. pestis and other clinically relevant bacteria.

According to the method of the disclosed invention, it was discovered that polyamine analogues containing bulky hydrophobic groups are effective antimicrobial agents against Yersinia pestis, as well as other clinically relevant bacteria. These polyamine analogues become antimicrobial agents by disrupting the bacterium's outer membrane. Because the polyamine analogues work through a mechanical mode of action and not through relying on specific targets, the disclosed method of using polyamine analogues has the potential for a wide spectrum of antimicrobial activity.

According to the method of the present invention a group of polyamine analogues having substituted hydrophobic bases is obtained. The polyamine analogues having substituted hydrophobic bases are then inserted into the bacterial cells in a sufficient concentration to mechanically disrupt the protective outer membrane. The mechanically disruption of the protective outer membrane results in cell death.

### BRIEF DESCRIPTION OF THE DRAWING FIGURES

A still better understanding of the method of the present invention may be obtained by reference to the drawing figures wherein:

FIG. 1A shows the Class A polyamine analogues XBI-54-13B, XBI-54-14B, XBI-54-12D, and BW-1 containing bulky hydrophobic moieties;

FIG. 1B shows the Class B polyamine analogues MLC-75-14B, MLC-75-14C, and 1C not containing bulky hydrophobic moieties;

FIG. 2A shows the results of uptake of 0.2 μM [¹⁴C] putrescine in Y. pestis KIM6+ and E. coli K12;

FIG. 2B shows the results of transport with the addition of 10 μM [¹⁴C] spermidine in Y. pestis KIM6+ and E. coli K12;

FIG. 3A shows the reaction of Nitrocefin with the K12 cells+ pBR322;

FIG. 3B shows the reaction of Nitrocefin with the K12 cells+ pBR322, plus mellitin;

FIG. 3C shows the reaction of Nitrocefin with the K12 cells+ pBR322, plus Class A polyamine analogue XBI-54-13B;

FIG. 3D shows the reaction of Nitrocefin with the K12 cells+ pBR322, plus Class B polyamine analogue 1C;

FIG. 4 shows the MIC (μg/ml) values of the active polyamine analogues in Y. pestis KIM6+; and

FIG. 5 shows the MIC (μg/ml) values of the active polyamine analogues in Escherichia coli, Pseudomonas aeruginosa, Staphylococcus aureus, and Enterococcus faecalis.

### DESCRIPTION OF THE EMBODIMENTS

It has been documented that mutations in the polyamine pathway result in clinically advantageous phenotypes in bacteria. In the development of the disclosed invention, a series of polyamine analogues exhibiting strong antimicrobial effects were tested to mimic these naturally occurring genetic mutations. These antimicrobial effects function through the mechanical disruption of the protective outer membrane of the bacteria.

The polyamine analogues are effective in disrupting the cell walls of both Gram positive and Gram negative bacteria because the mechanism of the action of the analogues does not rely on the specificity of the polyamine analogues to a particular target. The cells walls of the Gram positive and Gram negative bacteria differ in composition. The cell wall of Gram positive bacteria contains peptidoglycan known as murein, polysaccharides, and/or teichoic acid. The peptidoglycans are heteropolymers of glycan strands, cross-linked through short peptides consisting of both L- and D-amino acids.

As opposed to the cell wall of Gram positive bacteria, the cell of wall of Gram negative bacteria is much more conserved. The cell wall of Gram negative bacteria is mainly composed of lipopolysaccharide (LPS), phospholipids, lipoprotein, and a small amount of peptidoglycan. Gram negative bacteria contain an outer membrane consisting of strongly negative lipopolysaccharide cross-linked via divalent cations (Mg²⁺, Ca²⁺). This LPS layer is believed to cause a reduction in effectiveness of hydrophobic antibiotics on Gram negative bacteria.

The simple polyamine structures, putrescine, spermidine, or spermine, are able to displace the divalent cations and bind tightly to the LPS without altering its packing arrangement. Although, it has been shown that more complex polycationic structures, particularly those which contain a number of amino groups and bulky hydrophobic moieties, are capable of interacting with the LPS to disrupt the protective outer membrane of the bacteria.

The antimicrobial effects of polyamine insertion into the protective outer membrane of the Gram negative, enteric bacterium, Y. pestis, was studied. Y. pestis is a bipolar staining coccobacilli that produces a thick anti-phagocytic slime layer. Pathogenic Y. pestis produces two anti-phagocytic components, the F1 and the VW antigens. Both are required for virulence and are only produced when Y. pestis is grown at 37° C., and not at lower temperatures. The bacteria is not virulent in its flea host as the flea's body temperature nears 25° C.

KIM6+ was the Y. pestis strain used for polyamine transport assays and for testing antimicrobial sensitivity in the KIM6+ strain. This KIM6+ strain is avirulent due to lack of the low-calcium response plasmid pCDI which contains genes that allow the KIM6+ to evade the immune system and allow infection of the lymph system. Other strains used in the MIC evaluation include: Escherichia coli (ATCC 25922), Staphylococcus aureus (ATCC 25923), Pseudomonas aeruginosa (ATCC 27853), and Enterococcus faecalis (ATCC 7080).

Two classes of polyamine analogues, originally designed as antitrypanosomal agents, were tested for antimicrobial effects in Y. pestis. Polyamine analogues containing bulky hydrophobic moieties exhibited bactericidal effects at low concentrations, while similar analogues without these bulky groups did not exhibit antimicrobial characteristics. Membrane disruption assays indicated that bactericidal effects are the result of the polyamine analogues disrupting the outer membrane of the cell, as opposed to the intracellular transport of polyamine analogues and the resulting effect within the cell. The polyamine analogues maintain effectiveness even in the presence of exogenously added polyamines. The antimicrobial effects following the insertion of the polyamine analogues within the outer membrane of many different types of bacteria are far reaching.

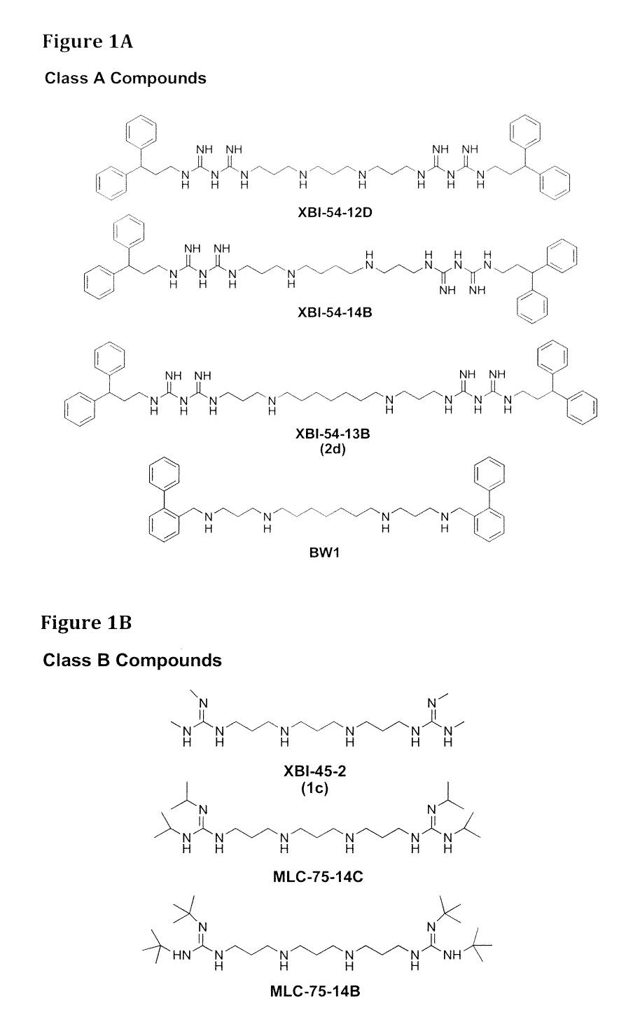

Four Class A polyamine analogues containing bulky hydrophobic moieties (shown in FIG. 1A) were tested. The Class A analogues (shown in FIG. 1), XBI-54-13B, XBI-54-14B, and XBI-54-12D, are polyaminobiguanides with 3-7-3, 3-4-3, and 3-3-3 carbon backbones, respectively. BW-1 is a previously described antitrypanosomal agent.

The Class A polyamine analogues were originally developed as antiparasitic agents based on the hypothesis of their entry into cells via the polyamine transport system. Entry into the cells would be followed by the subsequent disruption of polyamine metabolism because of altered pKa values associated with the biguanide moieties. The biguanide group appears in a number of important therapeutic agents, including chlorhexidine and the antimalarial chlorguanide.

Because the Class A analogues were originally designed to enter the cell via the polyamine transport system, a profile of polyamine transport in Y. pestis was developed. The polyamine transport system of E. coli was then used as a model for the Y. pestis system, as it is one of the best known and characterized polyamine transport systems.

In the E. coli polyamine transport system, polyamine uptake follows the general order: putrescine, followed by spermidine, followed by spermine. Transport in E. coli occurs via the ATP binding cassette (ABC) transporters, potABCD a spermidine preferential system and potFGHI, a putrescine specific system. The pot transporters consist of four proteins: PotA (PotG) is an ATPase providing energy for transport, PotB (PotH) with PotC (PotI) form a channel though the bilayer, and PotD (PotF) is the polyamine recognition protein located in the periplasm. The PotABCD system is considered spermidine preferential, but it is also able to transport putrescine. The potFGHI system is specific for putrescine.

Class B polyamine analogues without bulky hydrophobic moieties (shown in FIG. 1B) were tested to further understand the importance of the substituted bulky hydrophobic moieties of the Class A polyamine analogues. The Class B polyamine analogues were similar in basic structure to the Class A polyamine analogues with guanidine moieties, yet the Class B polyamine analogues lacked the substituted bulky hydrophobic groups. The Class B polyamine analogues used in the evaluation were: MLC-75-14B, MLC 75-14C, and 1C.

The MIC was defined as the lowest concentration of compound that completely inhibited the growth of the inoculums. Polyamine analogue susceptibility was determined by a standard broth micro-dilution method. The media used to test the MIC in Y. pestis was Heart Infusion Broth (HIB), while the other bacteria were tested in Tryptic Soy Broth (TSB). The polyamine analogues were added to the media in a 96-well plate in such a manner as to create a serial twofold dilution from 200 to 0.38 μg/ml. Bacterial cells were collected at mid-log phase and inoculums were added to each well at a final concentration of ˜10⁶ cells. The plates were then incubated for 18 hours at 37° C.

The Y. pestis Kim6+ cells started growing on PMH2 slants, a defined media lacking polyamines. The E. coli K12 cells started growing on M9 media slants. Both bacterium were allowed to grow overnight at 37° C. The cells were washed from the corresponding slant with PMH2 and M9 media, respectively. A 5 ml culture was started at an OD of 0.1 and allowed to reach exponential growth.

The reaction for spermidine was started with the addition of 50 μl of 1 mM spermidine (0.05 mM [¹⁴C] Spermidine/0.95 mM unlabeled Spermidine). The putrescine reaction was started with the addition of 50 μl of 20 μM [¹⁴C] putrescine. The bacterial cells were incubated at 37° C. with 0.5 ml of cells collected at various time points by vacuum filtration on membrane filters (0.45 μm, MF-Millipore). The membrane filters were pre-soaked in media containing 10 μm spermidine or putrescine. The membrane filters were washed twice with a total of 8 ml of media and suspended in Bio-Safe II counting cocktail (Research Products International).

The counts per minute of each sample were measured on a Beckman LS6500 liquid scintillation spectrometer. Unfiltered samples determined the total radioisotope content of cultures in each experiment.

To demonstrate energy-dependent uptake and correct for nonspecific binding, control cultures were metabolically poisoned with 100 μM carbonyl cyanide mchlorophenylhydrazone (CCCP) 10 min before the addition of the isotope.

The Y. pestis Kim6+ cells were first tested in the outer membrane assay, but the Y. pestis cells passively excreted the β-lactamase at a rate that made it difficult to clearly monitor actual disruption of the protective outer membrane of the cells. To properly monitor the disruption of the protective outer membrane, E. coli K12 cells were transformed instead with the plasmid pBR322. The pBR322 plasmid encoded the K12 cells with constitutive periplasmic β-lactamase. The cells were grown overnight in LB+Ampicillin (100 μg/ml) at 37° C. The following day, the cells were back diluted to an OD 0.3. The cells were then washed with 10 mM Sodium Phosphate Buffer pH 7.0 to remove any β-lactamase released into the growth media, combined with Nitrocefin, and monitored in a 96-well plate using a UV plate reader.

Disruption of the protective outer membrane of the E. coli K12 cells was monitored using the chromogenic β-lactamase substrate Nitrocefin which changes color from yellow (λₘₐₓ=390 nm) to red (λₘₐₓ=486 nm) when the amide bond in the βlactam ring is hydrolyzed by β-lactamase. Due to the limited availability of pure chromogenic β-lactamase substrates, the Nitrocefin used in this experiment was obtained by solubilizing 6 mm disks impregnated with Nitrocefin (Sigma) in 10 mM Sodium Phosphate Buffer pH 7.0. The concentration of the Nitrocefin in solution was determined using the absorption at 390 nm and its extinction coefficient (γ=11500 M⁻1cm⁻1).

Assay mixtures consisted of 100 ul of cells in 96-well plates at an OD ˜0.3 in 10 mM Sodium Phosphate Buffer pH 7.0 that contained 50 μg/ml Nitrocefin. Either polyamine analogues or the positive control, mellitin (Sigma), were added to a final concentration of 10 μg/ml.

β-lactamase hydrolyzation was monitored at 486 nm at 37° C. using a SpectraMax 5 (Molecular Devices) plate reader set to the kinetics mode of the Softmax Pro 5 software.

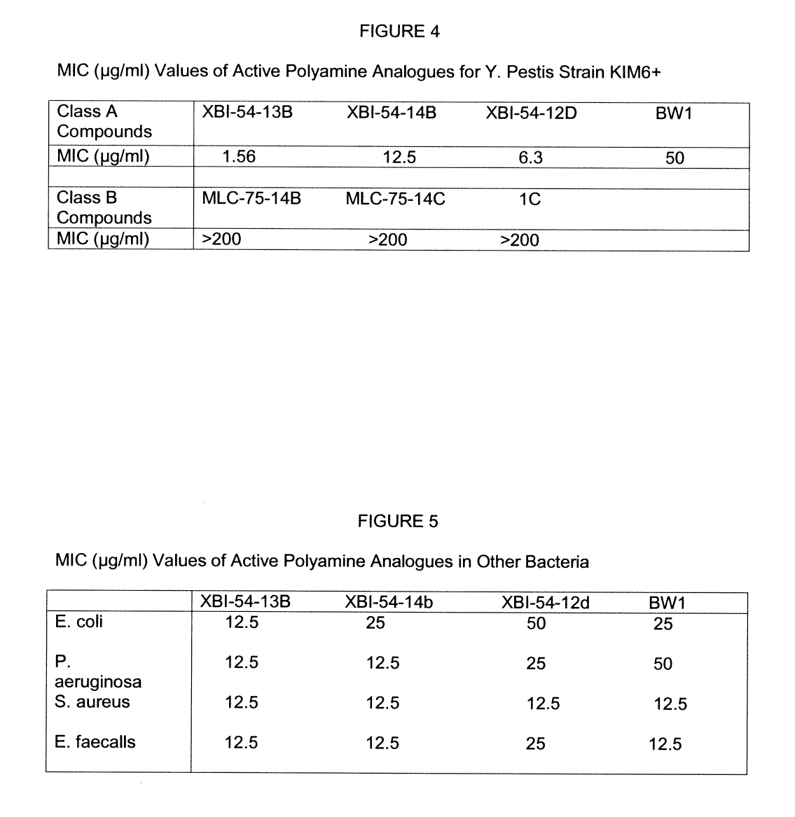

FIG. 4 shows the MIC values determined for each compound against Y. pestis. All of the polyamine analogues within Class A exhibited strong antimicrobial activity. Analogue XBI-54-13B exhibited the strongest effect at a concentration of 1.56 μg/ml. FIG. 4 shows that these polyamine analogues lacked any antimicrobial activity within the range of the MIC assay used. Comparing the results and structures of the Class B polyamine analogues to that of the Class A polyamine analogues, the presence of the large hydrophobic groups in the Class A polyamine analogues played a significant role in the mode of action of these polyamine analogues.

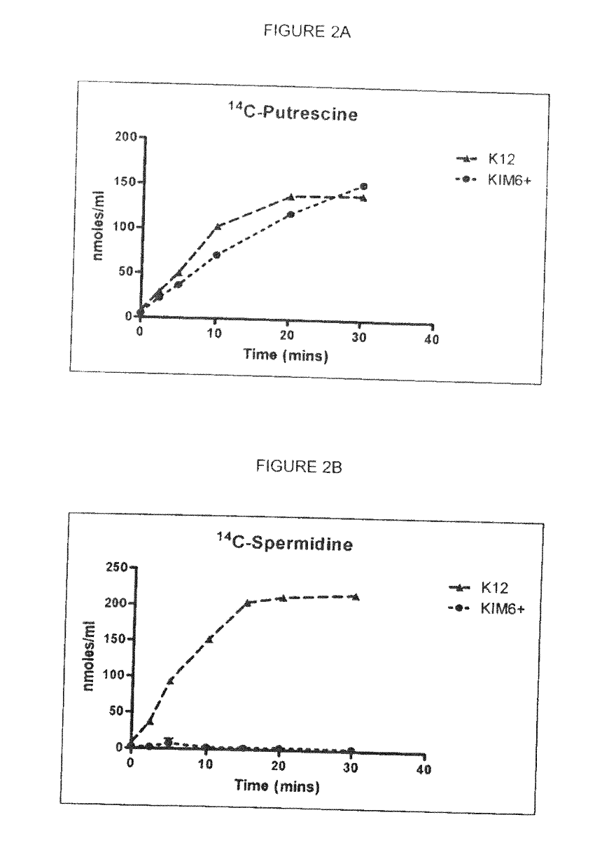

As previously shown through HPLC analysis, the two main polyamines produced by Y. pestis are putrescine and spermidine. FIG. 2A shows the uptake of 0.2 putrescine in Y. pestis and E. coli K12. Both strains show the ability to transport significant amounts of putrescine. FIGS. 2A and 2B show a comparison of the transport of ¹⁴C labeled putrescine (A) and ¹⁴C labeled spermidine in both Y. pestis and E. coli K12. Uptake is reported in nmol/ml adjusted to a common OD of 0.4.

FIG. 2B shows the results of transport with the addition of 10 μM [¹⁴C] spermidine. E. coli K12 is able to transport a significant amount of spermidine. However, the levels of spermidine transport in Y. pestis were no different between untreated cells and those treated with the ATP uncoupler CCCP (carbonyl cyanide m-chlorophenyl hydrazone) (data not shown).

The results illustrated by the line along horizontal axis of the graph shown in FIG. 2B indicate that Y. pestis is effectively unable to transport spermidine. These results correlate to the varying degree of genetic similarities found between the polyamine binding proteins of the E. coli Pot transport system and Y. pestis. A BLAST search of the Y. pestis Kim genome in TIGR Comprehensive Microbial Resource database using the potF (b0854) and potD (b1123) genes of E. coli K12 identified correlating genes in Y. pestis; y2851 (1.5e⁻¹³⁸) and y1391 (5.7e⁻¹²) respectively. The similarity of the spermidine preferential potD gene is much lower. The low degree of similarity and the lack of spermidine uptake indicates that the potD gene likely does not function as a spermidine transporter. This data correlates with the inability to restore the biofilm defects in a polyamine deficient mutant by the addition of exogenous spermidine.

Because the polyamine transport is selective for the transport of putrescine, the polyamine analogues were tested against Y. pestis in the presence of varying concentrations of putrescine. The addition of 0.1 mm, 1 mm, and 10 mm of putrescine had no effect on the effectiveness of the polyamine analogues (data not shown). As a result, these polyamine analogues are not riding the transport system into the cell and disrupting polyamine homeostasis.

Because of the differences in the effectiveness of the two groups of polyamine analogues found in FIGS. 1A and 1B, and based on the previously published data characterizing the ability of polycationic molecules to disrupt the outer membrane of Gram negative bacteria, like Y. pestis, it has been concluded that the mechanical disruption of the protective outer membrane of the cell represents the mode of action of the effective Class A polyamine analogues.

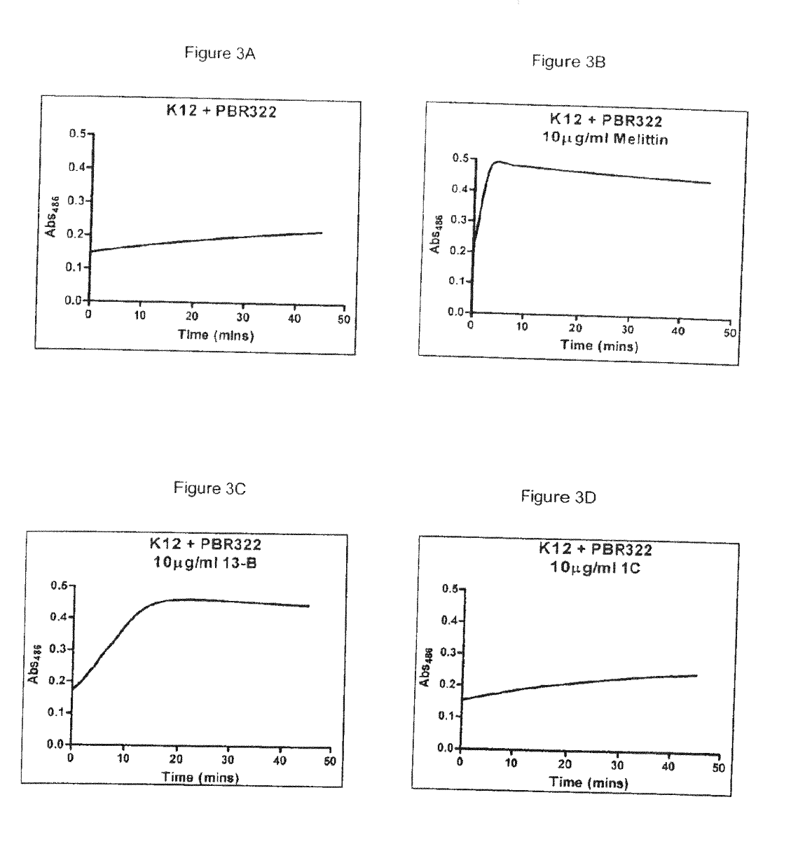

FIG. 3A is a graph showing the reaction of Nitrocefin with the K12 cells+ pBR322, alone, over a 45 min incubation period. While the absorption at 486 nm increases slightly over the 40+ minute time period indicating some release of βlactamase, it clearly does not show the dramatic increase in absorption as shown with the positive control, melittin, adjacent the vertical axis of the graph shown in FIG. 3B. Mellitin, a cytotoxic peptide known to permeabilize bacterial membranes, is the principle active ingredient in bee venom. In the presence of mellitin, a reaction of Nitrocefin to β-lactamase occurs almost immediately.

FIG. 3C is a graph showing the effect on the outer membrane permeabilization of the most potent of the Class A polyamine analogues, 13-B. Similar to mellitin, the 13-B polyamine analogue quickly causes a release of β-lactamase, resulting in the increase in absorption at 486 nm.

Contrasting this increase in absorption of the Class A polyamine analogues is the addition of one of the polyamine analogues from the Class B group. FIG. 3D shows that the addition of compound 1C does not result in antimicrobial activity and does not differ in its effect than K12 cells with pBR322 alone.

The active Class A polyamine analogues were also tested in other clinically relevant bacterium besides Y. pestis. These clinically relevant bacterium tested include: E. coli, P. aeruginosa, E. faecalis, and S. aerus. Like Y. pestis, the polyamine analogues exhibited antimicrobial properties (shown in FIG. 5) against each of these other bacterium.

The example demonstrating that the protective outer membrane of bacterial cells was mechanically disrupted by the method of applying polyamine analogues to create antimicrobial effects on the bacterial cells included the following steps:

obtaining a group of Class A polyamine analogues, having substituted hydrophobic bases;

obtaining a group of Class B polyamine analogues, not having substituted hydrophobic bases;

determining the MIC value as the lowest concentration of both the Class A and the Class B polyamine analogues that completely inhibit the growth of bacteria by micro-broth dilution.

The step of determining the MIC value included:

adding the Class A polyamine analogues and the Class B polyamine analogues individually to an appropriate media to create a dilution;

collecting bacterial cells at the mid-log phase;

adding inoculums to reach an appropriate concentration of bacterial cells;

incubating the bacterial cells.

Next, a polyamine analogue uptake assay was performed for the Class A polyamine analogues and the Class B polyamine analogues. The polyamine analogue uptake assays included the following steps:

growing bacterial cells on appropriate slants;

washing the bacterial cells from the slants with appropriate media;

adding appropriate amounts of spermidine and putrescine to the bacterial cells;

incubating the bacterial cells;

collecting the bacterial cells at various time points from spermidine-soaked or putrescine-soaked membrane filters;

washing the membrane filters with an appropriate media;

counting the bacterial cells using a spectrometer.

The last step included performing an outer membrane assay to assess the protective outer membrane permeabilization for the Class A polyamine analogues and the Class B polyamine analogues. The outer membrane assays including the following steps:

transforming the bacterial cells with plasmids to encode the bacterial cells with periplasmic β-lactamase;

growing and incubating the bacterial cells with Ampicillin;

back-diluting and washing the bacterial cells with sodium phosphate buffer to remove β-lactamase released into growth media;

monitoring membrane disruption in the bacterial cells using Nitrocefin in sodium phosphate buffer;

monitoring β-lactamase hydrolyzation using a plate reader.

The foregoing invention has been described according to its preferred embodiment. Those of ordinary skill will understand that other embodiments of the method of the present invention are enabled by the foregoing disclosure. Such embodiments shall be included within the scope and meaning of the appended claims.

What is claimed is:

1. A method for effecting antimicrobial activity on bacterial cells using polyamine analogues, said method comprising the steps of:
adding the polyamine analogues containing bulky hydrophobic moieties to the bacterial cells in a sufficient amount and concentration to mechanically disrupt the protective outer membrane of the bacterial cells.

2. The method as defined in claim 1 wherein said bulky hydrophobic moieties are hydrophobic bases.

3. The method as defined in claim 1 wherein the polyamine analogues are polyaminobiguanides with 3-7-3, 3-4-3 and 3-3-3 carbon backbones.
